(19) United States
(12) Patent Application Publication
(10) Pub. No.: US 2025/0082029 A1
(43) Pub. Date: Mar. 13, 2025

(54) AEROSOL GENERATING DEVICE AND SYSTEM INCLUDING THE SAME

(71) Applicant: KT&G CORPORATION, Daejeon (KR)

(72) Inventors: Young Bum KWON, Gyeonggi-do (KR); Hun II LIM, Seoul (KR); Dong Sung KIM, Seoul (KR); Yong Hwan KIM, Gyeonggi-do (FR)

(73) Assignee: KT&G CORPORATION, Daejeon (KR)

(21) Appl. No.: 18/566,909

(22) PCT Filed: May 17, 2023
(86) PCT No.: PCT/KR2023/006700

§ 371 Date: Dec. 4, 2023

(30) Foreign Application Priority Data
Jun. 16, 2022 (KR) 10-2022-0073786
Oct. 5, 2022 (KR) 10-2022-0127174

(51) Int. Cl. A24F 40/465; A24D 1/20; A24F 40/10; A24F 40/42; A24F 40/44; A24F 40/51; A24F 40/57; A24F 40/60; H05B 6/10; H05B 6/44

(52) U.S. Cl. CPC A24F 40/465; A24D 1/20; A24F 40/10; A24F 40/42; A24F 40/44; A24F 40/51; A24F 40/57; A24F 40/60; H05B 6/108; H05B 6/44

(57) ABSTRACT

An aerosol generating system includes an aerosol generating article including an aerosol generating material, a housing forming an exterior and having an inner space, an accommodation portion inside the housing and configured to accommodate the aerosol generating article, a battery inside the housing, a heating element inside the housing and configured to generate a magnetic field according to power from the battery, and a susceptor emitting heat because of the magnetic field generated by the heating element and configured to heat the aerosol generating article, wherein at least a portion of the heating element forms coils configured to generate the magnetic field, and the coils are electrically connected to each other, arranged along an outer circumferential surface of the accommodation portion, and configured to generate the magnetic field in a direction crossing a direction, in which the accommodation portion extends, when the power is supplied from the battery.

### TECHNICAL FIELD

The disclosure relates to an aerosol generating device and a system including the same, and more particularly, to an aerosol generating device capable of effectively heating a miniaturized susceptor.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research into a heating-type aerosol generating device has been actively conducted.

Recently, an induction-heating type aerosol generating device, which generates an aerosol by heating a cigarette or an aerosol generating material by using an alternating magnetic field, has been suggested. In particular, the induction-heating type aerosol generating device may include a coil, which generates an alternating magnetic field according to supply of power, and a susceptor, which generates heat when the alternating magnetic field generated by the coil is applied, and may generate aerosols from an aerosol generating material by heating an aerosol generating article with the heat generated by the susceptor.

### DISCLOSURE OF INVENTION

### Technical Problem

An induction-heating type aerosol generating device may include a susceptor and a coil, and the susceptor may be heated by a magnetic field generated by the coil and thus may transfer heat energy to an aerosol generating article.

Recently, to increase the portability and convenience of a user, attempts have been made to reduce sizes of aerosol generating devices. There is a need to miniaturize a susceptor for heating an aerosol generating article and/or a coil to reduce a size of an induction-heating type aerosol generating device. For example, the susceptor may decrease in size as a metal thin-film.

However, coils used in an existing induction-heating type aerosol generating device may be in the form of spiral solenoids around which a conducting wire, in which a current flows, is wound several times at certain intervals in a lengthwise direction of a virtual cylinder. Because a ratio of a magnetic field passing through a space with no susceptor to magnetic fields generated by the coils increases in the solenoid coils, the susceptor may not be sufficiently heated, and thus, an aerosol generating article may not be effectively heated.

Technical problems to be solved by the disclosure are to provide a heating element capable of effectively heating a miniaturized susceptor, an aerosol generating device including the heating element, and an aerosol generating system.

Other technical problems are to provide an aerosol generating device including a heating element, which includes a plurality of coils integrally connected to each other, and effectively controlling the heating element to prevent an offset of a magnetic field generated by the coils, and an aerosol generating system.

The technical problems of the disclosure are not limited to the aforementioned description, and other technical problems that are not stated herein may be clearly understood by one of ordinary skill in the art to which embodiments of the disclosure pertain, from the present specification and the attached drawings.

### Solution to Problem

According to an embodiment, an aerosol generating device includes a housing forming an exterior and having an inner space, an accommodation portion arranged inside the housing and configured to accommodate an aerosol generating article, a battery arranged inside the housing, a heating element arranged inside the housing and configured to generate a magnetic field according to power supplied from the battery, wherein at least a portion of the heating element forms a plurality of coils configured to generate the magnetic field, and the plurality of coils are electrically connected to each other, arranged along an outer circumferential surface of the accommodation portion, and configured to generate the magnetic field in a direction crossing a direction, in which the accommodation portion extends, when the power is supplied from the battery.

According to an embodiment, an aerosol generating system includes an aerosol generating article including an aerosol generating material, a housing forming an exterior and having an inner space, an accommodation portion arranged inside the housing and configured to accommodate the aerosol generating article, a battery arranged inside the housing, a heating element arranged inside the housing and configured to generate a magnetic field according to power supplied from the battery, and a susceptor emitting heat because of the magnetic field generated by the heating element and configured to heat the aerosol generating article, wherein at least a portion of the heating element forms a plurality of coils configured to generate the magnetic field, and the plurality of coils are electrically connected to each other, arranged along an outer circumferential surface of the accommodation portion, and configured to generate the magnetic field in a direction crossing a direction, in which the accommodation portion extends, when the power is supplied from the battery.

### Advantageous Effects of Invention

According to various embodiments, an aerosol generating device and an aerosol generating system may effectively heat a miniaturized susceptor and thus improve the heating efficiency of an aerosol generating article.

Also, according to one or more embodiments, an aerosol generating device and an aerosol generating system may effectively control a heating element to prevent a magnetic field, which is generated by a plurality of coils included in the heating element, from being offset.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 is a cross-sectional view of an aerosol generating device and an aerosol generating article, according to an embodiment.

FIG. 2 illustrates a heating element of an aerosol generating device, according to an embodiment.

FIG. 3 illustrates an arrangement of a heating element of an aerosol generating device, according to an embodiment.

FIG. 4 is a cross-sectional view for explaining operations of a heating element of an aerosol generating device, according to an embodiment.

FIG. 5 is a cross-sectional view for explaining operations of a heating element of an aerosol generating device, according to an embodiment.

FIG. 6 illustrates an aerosol generating article according to an embodiment.

FIG. 7 illustrates an arrangement of a heating element of an aerosol generating device, according to an embodiment.

FIG. 8 illustrates a heating element of an aerosol generating device, according to an embodiment.

FIG. 9 is a block diagram for explaining operations of an aerosol generating device, according to an embodiment.

### BEST MODE FOR CARRYING OUT THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

A direction in which a certain component extends indicates a direction in which a length of the component extends.

In an embodiment, an aerosol generating device may generate aerosols by heating an aerosol generating article accommodated in the aerosol generating device, according to an induction heating method.

The induction heating method may be a method by which heat is generated from a magnetic substance by applying an alternating magnetic field.

When an alternating magnetic field is applied to the magnetic substance, energy may be lost in the magnetic substance because of eddy currents and hysteresis loss. The lost energy may be emitted from the magnetic substance as heat energy. The greater an amplitude or a frequency of an alternating magnetic field applied to the magnetic substance is, the more heat energy may be emitted from the magnetic substance.

The aerosol generating device of an induction heating type may include a susceptor and a coil. Optionally, the susceptor may be positioned within the aerosol generating article. The susceptor may be arranged adjacent to the aerosol generating article outside the aerosol generating article. As power is supplied to the coil, the coil may generate a magnetic field and apply the magnetic field to the susceptor.

Selectively, the susceptor may include a magnetic substance that emits beat when an external magnetic field is applied. As another example, the susceptor may include non-magnetic metal. When the magnetic field is applied to the susceptor arranged inside the coil, the susceptor may emit heat and heat the aerosol generating article.

In an embodiment, the coil may be a spiral solenoid around which a conducting wire, in which a current flows, is wound several times at certain intervals in a lengthwise direction of a virtual cylinder.

When a current flows in the coil of a solenoid type, a magnetic field passing through an inner space surrounded by the coil may be generated. According to Ampere's Law, a direction of the magnetic field, which is generated due to the current flow in the solenoid coil, is parallel to a direction of a central axis of a virtual cylinder wound by the coil. The intensity of the magnetic field generated due to the current flow in the solenoid coil is uniform regardless of the location in the inner space surrounded by the coil, and the intensity is proportional to the number of turns of the coil per unit length and the intensity of the current flowing in the coil.

In an embodiment, a virtual cylindrical space may be formed in the inner space surrounded by the solenoid coil, and an accommodation portion for accommodating at least a portion of the aerosol generating article may be arranged in the above space. In this case, a magnetic field may be generated in a direction that is the same as a direction in which the accommodation portion extends, and the magnetic field may pass through the aerosol generating article accommodated in the accommodation portion.

Because the intensity of the magnetic field generated according to the current flow in the solenoid coil is uniform regardless of a location in the inner space surrounded by the coil, the magnetic field may be uniformly applied to the accommodation portion and the aerosol generating article. That is, the magnetic field generated by the solenoid coil is not focused on a specific location, but uniformly generated in the entire inner space.

The smaller the susceptor arranged inside the solenoid coil becomes, the greater a ratio of a magnetic field passing through a space with no susceptor to magnetic fields generated by the coil becomes, and the ratio of the magnetic field applied to the susceptor may be reduced. Accordingly, the intensity of the magnetic field applied to the susceptor may be reduced, and the emission of heat energy of the susceptor compared to the current flowing in the coil is reduced, thereby degrading the energy efficiency.

For example, when the susceptor includes a film extending thinly in the direction in which the accommodation portion extends, most of the magnetic field passing through the inner space surrounded by most part of the coil may pass through a space with no susceptor, and the ratio of the magnetic field passing through the susceptor to the magnetic fields generated by the coil may greatly decrease. Thus, the susceptor may not be sufficiently heated and thus may fail to effectively heat the aerosol generating article.

The aerosol generating device is to solve the above problems, and the disclosure discloses an aerosol generating device of an induction-heating type which may effectively heat a miniaturized susceptor.

Hereinafter, the present disclosure will now be described more fully with reference to the accompanying drawings, in which exemplary embodiments of the present disclosure are shown such that one of ordinary skill in the art may easily work the present disclosure. The present disclosure may be realized in aerosol generating devices according to various embodiments or embodied in many different forms and should not be construed as being limited to the embodiments set forth herein.

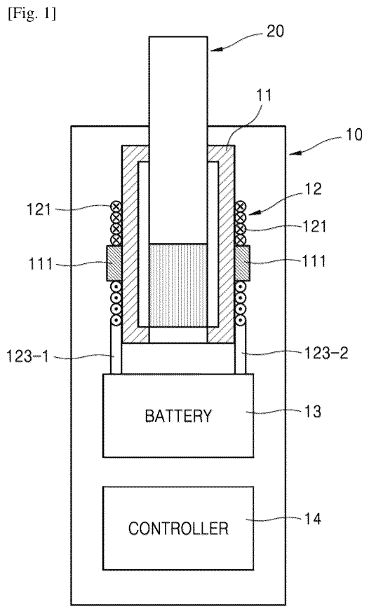

FIG. 1 is a cross-sectional view for explaining an aerosol generating device 10 and an aerosol generating article 20.

Referring to FIG. 1, the aerosol generating device 10 may include an accommodation portion 11, a heating element 12, a battery 13, and a controller 14. However, one or more embodiments are not limited thereto, and other components than the components illustrated in FIG. 1 may be further included in the aerosol generating device 10.

The aerosol generating device 10 may include a housing forming a general exterior of the aerosol generating device 10. In the housing, an inner space in which the components of the aerosol generating device 10 may be arranged may be formed. For example, the accommodation portion 11, the heating element 12, the battery 13, and/or the controller 14 may be arranged in the inner space of the housing, but one or more embodiments are not limited thereto.

A structure in which the accommodation portion 11, the heating element 12, the battery 13, and the controller 14 are arranged inside the housing of FIG. 1 may correspond to an embodiment of the disclosure, and according to an embodiment, the arrangements of the housing, the accommodation portion 11, the heating element 12, the battery 13, and the controller 14 may change.

The accommodation portion 11 may accommodate at least a portion of the aerosol generating article that may generate an aerosol. The accommodation portion 11 may have a cylindrical shape having a space where the aerosol generating article is accommodated. The accommodation portion 11 may include an opening that is open to the outside of the aerosol generating device 10 to accommodate the aerosol generating article 20. The opening of the accommodation portion 11 may be open towards the outside of the aerosol generating device 10.

The aerosol generating article 20 may be moved or inserted from the outside of the accommodation portion 11 towards the inside thereof through the opening in the accommodation portion 11 and thus may be accommodated in the accommodation portion 11.

The detailed description regarding the aerosol generating article 20 is provided below with reference to FIG. 6.

The heating element 12 may include one conducting wire and generate a magnetic field by receiving power from the battery 13. At least a portion of the conducting wire forming the heating element 12 may form a coil 121 that generates the magnetic field. In this case, the coil 121 may be provided in plural.

A detailed shape of the heating element 12 and an example regarding the generation of the magnetic field are described below in more detail with reference to other drawings.

The battery 13 may supply power to be used for the aerosol generating device 10 to operate.

In an embodiment, the battery 13 may supply power so that an alternating current may be applied to the heating element 12. For example, the battery 13 may be electrically connected to the heating element 12 through a first power supply line 123-1 and a second power supply line 123-2 and thus supply power to the heating element 12.

In another embodiment, power required for the operation of the controller 14 may be supplied. Also, the battery 13 may supply power for operations of a display, a sensor, a motor, and the like mounted in the aerosol generating device 10.

The controller 14 may generally control operations of the aerosol generating device 10. In detail, the controller 14 may control not only operations of the heating element 12 and the battery 13, but also operations of other components included in the aerosol generating device 10. Also, the controller 14 may check a state of each component of the aerosol generating device 10 to determine whether or not the aerosol generating device 10 is able to operate.

The controller 14 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The controller 14 may control power supplied by the battery 13 to the heating element 12. The operations of the controller 14 are described below with reference to FIG. 9.

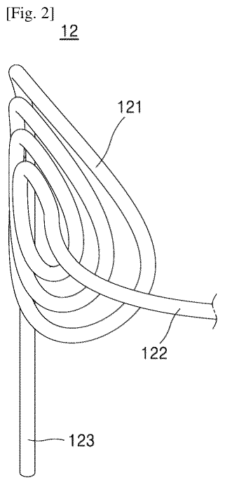

FIG. 2 illustrates shapes of the coil 121, a coil connector 122, and power supply lines 123 which form the heating element 12 of the aerosol generating device 10, according to an embodiment.

The heating element 12 may include one continuous conducting wire. The heating element 12 may include one or more coils 121 that generate a magnetic field. The heating element 12 may include multiple coils 121, but FIG. 2 illustrates only one coil 121 to describe a specific shape of the heating element 12.

The heating element 12 may be a single component in which a current flows, but because of the specific shape of the heating element 12, portions of the heating element 12 may serve necessary purposes, and accordingly, portions of the conducting wire forming the heating element 12 may be given different names.

The conducting wire forming the heating element 12 may be divided into the coil 121, the coil connector 122, and the power supply lines 123.

The coil 121 may have a shape in which the conducting wire, in which the current may flow, is wound multiple times. Unlike a solenoid coil winding a virtual cylinder several times in the same diameter, the coil 121 according to the present embodiment may be formed in a shape in which the diameter of the coil 121 gradually increases while the coil 121 winds the virtual central axis several times.

The coil 121 may form a curved surface. The coil 121 may be arranged such that the curved surface formed by the coil 121 surrounds at least a portion of an outer circumferential surface of the accommodation portion.

The coil connector 122 may be a conducting wire through which the coils 121 are electrically connected to one another. FIG. 2 illustrates that the coil connector 122 extends from an innermost conducting wire of the coil 121, but this is merely an example. The coil connector 122 may have various shapes that may connect the coils 121 to one another.

The power supply line 123 may be a conducting wire that receives power from the battery and supplies the power to the coil 121. FIG. 2 illustrates that the power supply line 123 extends from an outermost conducting wire of the coil 121, but this is merely an example, and the power supply line 123 may have various shapes that may connect the battery to the coil 121.

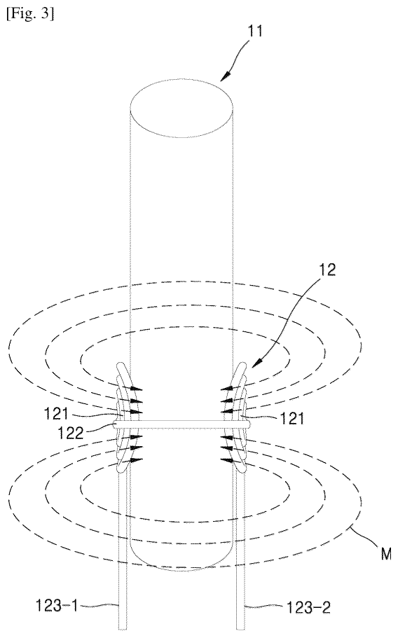

FIG. 3 illustrates a relative location relationship and arrangements of the accommodation portion 11 and the heating element 12 of an aerosol generating device, according to an embodiment.

The heating element 12 may be arranged outside the accommodation portion 11. The heating element 12 may include one or more coils 121 that generate a magnetic field M. As the heating element 12 includes one conducting wire, the coils 121 may be electrically connected to each other.

The coil 121 may be arranged along an outer circumferential surface of the accommodation portion 11. The coil 121 may be arranged such that a virtual central axis, around which the coil 121 is wound, crosses a direction (or a ‘lengthwise direction’) in which the accommodation portion 11 extends. For example, the coil 121 may be arranged such that the virtual central axis, around which the coil 121 is wound, is perpendicular to the direction in which the accommodation portion 11 extends, but the arrangement of the coil 121 is not limited thereto.

The coil 121 may be curved in the shape corresponding to the outer circumferential surface of the accommodation portion 11 and surround a portion of the outer circumferential surface of the accommodation portion 11, and at any locations in the coil 121, a distance from the coil 121 to the outer circumferential surface of the accommodation portion 11 may be uniformly maintained. A center point of the coil 121, at which the coil 121 is wound, may be at one point of the outer circumferential surface of the accommodation portion 11.

The coil 121 may be electrically connected to the battery by a pair of power supply lines 123 and thus receive the power from the battery. The power supply lines 123 may include the first power supply line 123-1 and the second power supply line 123-2.

As the coils 121 are electrically connected to each other by the coil connector 122 and receive a current through two power supply lines 123, the heating element 12 may include one conducting wire. Based on the structure of the aerosol generating device according to an embodiment in which the coils 121 are electrically connected to each other by the coil connector 122 and power is supplied to all of the coils 121 through two power supply lines 123, manufacturing costs of a configuration for power supply may be reduced, and the space utilization of the aerosol generating device may be improved. For example, in the case of the aerosol generating device including a structure in which power is supplied to each coil 121, power supply lines, of which the number corresponds to the number of coils, are required, whereas, in the aerosol generating device according to an embodiment, power is supplied to all of the coils 121 through only two power supply lines 123 or a pair of power supply lines 123, and thus, manufacturing costs of power supply lines may be reduced, and a space in which the power supply lines are mounted inside the aerosol generating device may decrease. Because it is unnecessary to supply power to each coil 121 due to the above-described structure, the amount of materials required to supply the power to the coils 121 and the manufacturing costs of the coils 121 may be reduced, and the space in the aerosol generating device may be effectively utilized.

The heating element 12 may be arranged such that the virtual central axis, around which the coils 121 are wound, crosses the direction in which the accommodation portion 11 extends. According to Ampere's Law, the magnetic field M generated by the heating element 12 may cross the direction, in which the accommodation portion 11 extends, and pass through the accommodation portion 11, in the above arrangement. In this case, an angle formed by a direction, in which the magnetic field M passes through the inside of the accommodation portion 11, and the direction, in which the accommodation portion 11 extends, may be substantially a right angle. The action of the magnetic field M in the accommodation portion 11 is described below in more detail with reference to FIG. 4.

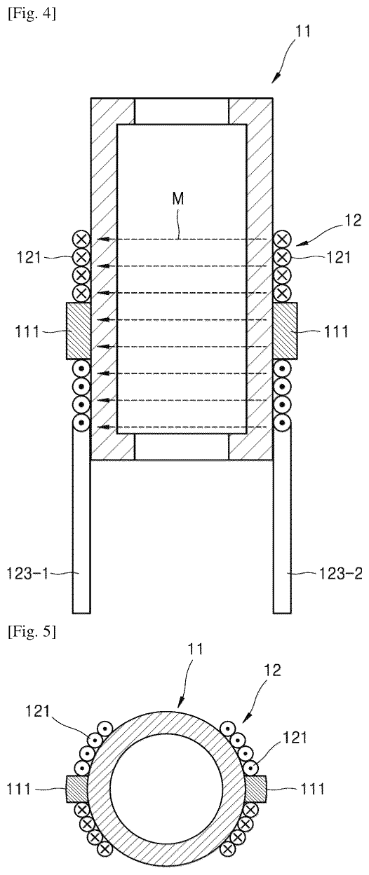

FIGS. 4 and 5 respectively are cross-sectional views for explaining operations of a heating element of an aerosol generating device. FIG. 4 is a cross-sectional view illustrating a state in which the accommodation portion 11 of the aerosol generating device according to an embodiment is viewed at a certain distance in a radial direction of the accommodation portion 11. FIG. 5 is a cross-sectional view illustrating a state in which the accommodation portion 11 of the aerosol generating device according to an embodiment is viewed at a certain distance in a direction in which the accommodation portion 11 extends.

Although not illustrated in FIGS. 4 and 5, in the inner space of the accommodation portion 11, a susceptor for heating an aerosol generating article may be accommodated. The susceptor may be arranged inside or outside the aerosol generating article.

According to Ampere's Law, a direction of the magnetic field formed by the coils 121 may be the same as a direction of the central axis around which the coils 121 are wound.

An alternating current may be applied to the coil 121 so that the coil 121 may generate the magnetic field M. A resonant frequency of the alternating current applied to the coil 121 may be greater than or equal to about 1 MHz and less than or equal to about 10 MHz. ‘X’ in the cross-section of the conducting wire forming the coil 121 of FIGS. 4 and 5 indicates a state in which a current flows in at a point in time when the cross-sectional view is viewed, and ‘·’ in the cross-section of the conducting wire indicates a state in which the current flows out at the point in time when the cross-sectional view is viewed. When the alternating current is applied to the coil 121, the direction of the current flowing in the coil 121 keeps changing according to a cycle of the alternating current, and thus, the direction of the current illustrated in FIGS. 4 and 5 may be temporary at a specific point in time.

When the alternating current is applied to the coil 121, the direction of the magnetic field M generated by the coil 121 may periodically change according to the cycle of the alternating current. Therefore, the direction of the magnetic field illustrated in FIGS. 4 and 5 is temporary at a specific point in time.

The coil 121 may be arranged such that the central axis, around which the coil 121 is wound, crosses the direction in which the accommodation portion 11 extends. Because of the above arrangement, the magnetic field M generated by the coil 121 may pass through the inner space of the accommodation portion 11 in a direction crossing the direction in which the accommodation portion 11 extends and may pass through the susceptor accommodated in the inner space of the accommodation portion 11, thereby heating the susceptor.

According to an embodiment, the susceptor may be formed as a thin film. When the susceptor is formed as a thin film, the heat emission efficiency compared to the volume occupied by the susceptor or the mass of the susceptor may be maximized, and thus, the power efficiency may be improved. Also, the volume occupied by the susceptor may decrease, and thus, the space of the aerosol generating device 10 may be effectively utilized. A thickness of the miniaturized susceptor may be greater than or equal to about 1 μm and less than or equal to about 100 μm.

The susceptor may be arranged in a manner that a direction in which the susceptor extends is the same as the direction in which the accommodation portion 11 extends. In the above arrangement, because the direction of the magnetic field M generated by the coil 121 crosses the direction in which the susceptor extends, the density of the magnetic field M passing through the susceptor may increase, and the heating efficiency of the susceptor may be improved compared to that when a solenoid coil is used.

That is, according to the present embodiment, because the magnetic field generated by the coil 121 may pass through a wide area of the susceptor even when the susceptor is miniaturized in the form of a thin film extending thinly in the lengthwise direction of the accommodation portion 11, a magnetic field with a sufficient density may be applied to the susceptor, and the susceptor may heat the aerosol generating article 20 at a sufficient temperature.

Unlike the solenoid coil, in the aerosol generating device 10 according to an embodiment, the direction of the magnetic field M crosses the lengthwise direction of the accommodation portion 11, the density of the magnetic field passing through the susceptor may increase, and thus, the heating efficiency of the susceptor may be improved compared to that when the solenoid coil is used.

The susceptor may include nonmagnetic metal, such as aluminum (Al). The non-magnetic metal may not be sufficiently heated according to the resonant frequency, because of low resistivity and relative permeability. When the susceptor includes the nonmagnetic metal and the alternating current is applied to the heating element 12, the resonant frequency of the alternating current applied to the coil 121 has to be between about 1 MHz and about 10 MHz to make the susceptor generate a sufficient amount of heat. The coil 121 may have a length, a diameter, and a material in a manner that the resonant frequency when the alternating current is applied may be between about 1 MHz and about 10 MHZ.

The susceptor may include metal or carbon. The susceptor may include at least one of ferrite, ferromagnetic alloy, stainless steel, and Al. Also, the susceptor may include at least one of ceramic, such as graphite, molybdenum (Mo), silicon carbide, niobium (Nb), nickel (Ni) alloy, a metal film, or zirconia, transition metal, such as Ni or cobalt (Co), and metalloid, such as boron (B) or phosphorus (P).

The coils 121 may have the same size and shape, and at least some of the coils 121 may be symmetrically arranged with respect to the accommodation portion 11.

Also, at least some of the coils 121 may be arranged to face each other with the accommodation portion 11 therebetween. At least some of the coils 121 may be spaced apart from each other at regular intervals.

In this case, when some of the coils 121 are symmetrically arranged with respect to the central axis of the accommodation portion 11, the magnetic field M generated by the coil 121 may be offset according to a direction in which the coil 121 is wound and a direction of a current flowing in the coils 121. When the magnetic field M generated by the coil 121 is offset, the heating efficiency of the heating element 12 may degrade.

Referring to FIGS. 4 and 5, in the aerosol generating device according to an embodiment, two coils 121 may be symmetrically arranged with respect to the accommodation portion 11. In this case, the two coils 121 may be arranged to have the same central axis and direction (a clockwise direction or a counterclockwise direction) in which the coils 121 are wound.

According to the above arrangement, because the currents flowing in respective coils 121 have the same direction (the clockwise direction or the counterclockwise direction) and the directions of the magnetic fields M generated by respective coils 121 are the same as each other, the magnetic fields M generated by the coils 121 having the same central axis may not be offset, but may overlap and become greater; thus, the efficiency of heating the susceptor may be improved.

At least a portion of the conducting wire forming one of the coils 121 may have a circular shape with a uniform radius with respect to the central axis around which the coil 121 is wound. The shape of the coil 121 is a concentric circle as circular conducting wires having different radiuses are arranged. A distance between a conducting wire forming one coil 121 and another conducting wire may be uniform, the density of the magnetic field M generated by the coil 121 may be uniform, the heat emission from the coil 121 may be minimized.

However, the shape of the coil 121 is not limited to a circle, and the number, the size, and the shape thereof may change according to necessity. For example, when viewed along the central axis of the coil 121, the coil 121 may have a square shape, and four coils 121 may be spaced apart from each other at equal intervals.

Because the magnetic field M generated by the coil 121 has a high magnetic flux density at the center of the coil winding, a portion adjacent to the center wound by the coil 121 of the aerosol generating article 20 inserted into the accommodation portion 11 may be possibly heated to a relatively high temperature compared to other portions. When multiple coils 121 are arranged, the center of the winding of the coil 121 is arranged at a plurality of points on an outer surface of the accommodation portion 11, and thus, the aerosol generating article 20 accommodated in the accommodation portion 11 may be evenly heated.

As the amplitude or frequency of the alternating current flowing in the coil 121 changes, the temperature of the susceptor heated by the magnetic field M may change. The controller may adjust the magnetic field M generated by the coil 121 by controlling the power supplied to the heating element 12, and the temperature of the susceptor may be controlled accordingly.

For example, the coil 121 may include copper (Cu), but is not limited thereto. The coil 121 may include an alloy including any one or at least one of silver (Ag), gold (Au), Al, tungsten (W), zinc (Zn), and Ni so that a high current may flow in the coil 121 with a low resistivity.

The accommodation portion 11 may include a protrusion 111 formed at a location corresponding to the center of the winding of the coil 121 arranged on the outer circumferential surface of the accommodation portion 11. The protrusion 111 may protrude from at least a portion of the outer circumferential surface of the accommodation portion 11 in the radial direction of the accommodation portion 11 and may support the heating element 12. For example, the protrusion 111 may be arranged at the center of the coil 121 and support the same.

The number of protrusions 111 may correspond to the number of coils 121. The protrusion 111 may have a shape corresponding to that of the coil 121 and suitable to support the same. For example, the protrusion 111 may have a shape in which a rectangle or a circle protrudes.

FIG. 6 illustrates an example of the aerosol generating article 20.

The aerosol generating article 20 may be a component that may be accommodated in the accommodation portion 11 described above. The aerosol generating article 20 may be heated by the heating element 12.

Referring to FIG. 6, the aerosol generating article 20 may include a tobacco rod 21 and a filter rod 22. FIG. 6 illustrates that the filter rod 22 includes a single segment, but the filter rod 22 is not limited thereto. In other words, the filter rod 22 may include a plurality of segments.

For example, the filter rod 22 may include a first segment configured to cool an aerosol and a second segment configured to filter a certain component included in the aerosol. Also, according to necessity, the filter rod 22 may further include at least one segment configured to perform other functions.

The aerosol generating article 20 may be packaged via at least one wrapper 24. The wrapper 24 may have at least one hole through which external air may be introduced or internal air may be discharged. For example, the aerosol generating article 20 may be packaged via one wrapper 24. As another example, the aerosol generating article 20 may be doubly packaged via at least two wrappers 24. For example, the tobacco rod 21 may be packaged via a first wrapper 24a, and the filter rod 22 may be packaged via wrappers 24b, 24c, and 24d. In addition, the entire aerosol generating article 20 may be repackaged via a single wrapper 24e. When the filter rod 22 includes a plurality of segments, each segment may be packaged via each of the wrappers 24b, 24c, and 24d.

The tobacco rod 21 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected into the tobacco rod 21.

The susceptor may be arranged inside the aerosol generating article. For example, the susceptor may be included in the tobacco rod 21. The susceptor may be arranged to surround at least a portion of the aerosol generating article 20. The susceptor may be arranged such that the direction in which the susceptor extends is the same as the direction in which the aerosol generating article 20 extends.

The tobacco rod 21 may be formed in various ways. For example, the tobacco rod 21 may be formed as a sheet or a strand.

Also, the tobacco rod 21 may be formed as a pipe tobacco, which is formed of tiny bits cut from a tobacco sheet.

Although not illustrated in FIG. 6, the aerosol generating article 20 may include the susceptor.

The susceptor included in the tobacco rod 21 may be manufactured in various forms. For example, the susceptor may be formed as a sheet and surround the tobacco rod 21. As another example, the susceptor may be formed as a strand or particle, and a plurality of susceptors may be distributed in the tobacco rod 21.

Also, the tobacco rod 21 may be surrounded by a heat conductive material. For example, the heat conductive material may be, but is not limited to, metal foil, such as aluminum foil. For example, the heat conductive material surrounding the tobacco rod 21 may evenly distribute heat transmitted to the tobacco rod 21, and thus, the heat conductivity applied to the tobacco rod 21 may be increased, and the taste of the aerosol generated from the tobacco rod 21 may be improved accordingly. Also, the heat conductive material surrounding the tobacco rod 21 may function as a susceptor heated by the magnetic field.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The filter rod 22 may generate flavors. For example, a flavoring liquid may be injected onto the filter rod 22, or an additional fiber coated with the flavoring liquid may be inserted into the filter rod 22.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

When the filter rod 22 includes a segment configured to cool the aerosol, the cooling segment may include a polymer material or a biodegradable polymer material. For example, the cooling segment may include pure polylactic acid alone, but the material for forming the cooling segment is not limited thereto. Alternatively, the cooling segment may include a cellulose acetate filter having a plurality of holes. However, the cooling segment is not limited to the above-described example and is not limited as long as the cooling segment cools the aerosol.

Although not illustrated in FIG. 6, the aerosol generating article 20 may further include a front-end plug. The front-end plug may be located on a side of the tobacco rod 21, the side facing the filter rod 22. The front-end plug may prevent the tobacco rod 21 from being detached outwards and prevent a liquefied aerosol from flowing into the aerosol generating device 10 (FIG. 1) from the tobacco rod 21, during smoking.

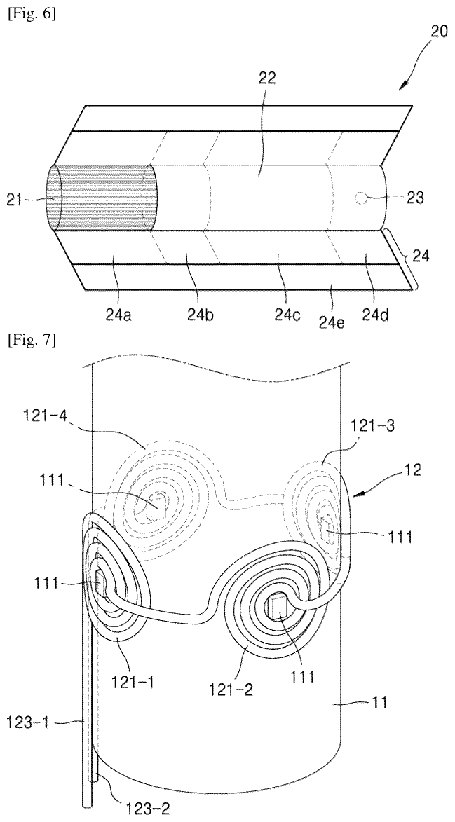

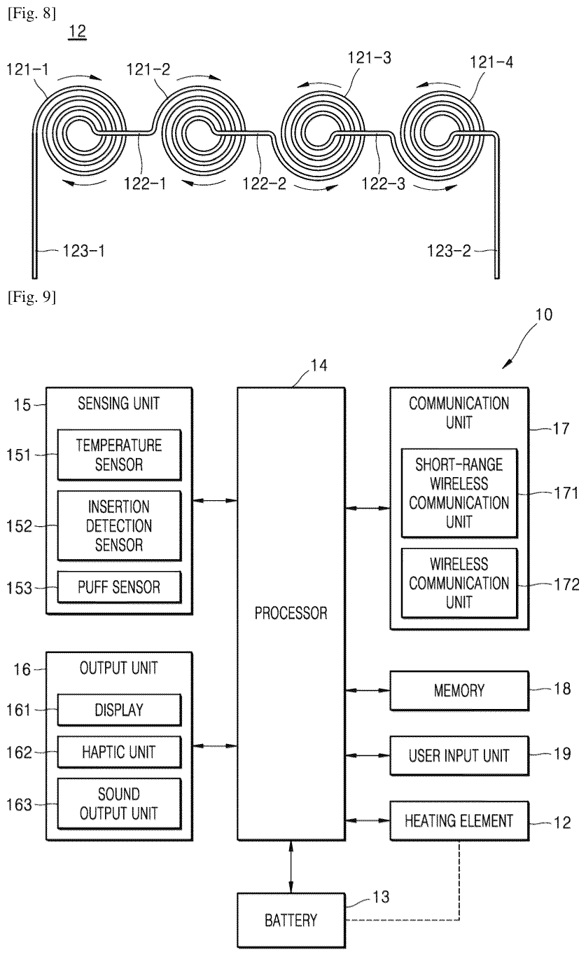

FIGS. 7 and 8 illustrate examples in which the heating element 12 of the aerosol generating device 10 includes four or more coils 121.

FIG. 7 is a diagram for explaining a state in which the heating element 12 including four coils 121 is arranged on an outer circumferential surface of the accommodation portion 11 of the aerosol generating device 10.

FIG. 8 is a diagram for explaining a state in which the heating element 12 including four coils 121 is exploded on a plane.

The heating element 12 of FIGS. 7 and 8 may be formed of one conducting wire and include a first coil 121-1, a second coil 121-2, a third coil 121-3, and a fourth coil 121-4.

The first coil 121-1 and the second coil 121-2 may be connected to each other by a first coil connector 122-1, the second coil 121-2 and the third coil 121-3 may be connected to each other by a second coil connector 122-2, and the third coil 121-3 and the fourth coil 121-4 may be connected to each other by a third coil connector 122-3.

A first power supply line 123-1 and a second power supply line 123-2 may supply power to the coils 121-1, 121-2, 121-3, and 121-4.

Referring to FIGS. 7 and 8, the heating element 12 may include one conducting wire, the coils 121-1, 121-2, 121-3, and 121-4 may be electrically connected to each other by the coil connectors 122-1, 122-2, and 122-3, and the power supply to the heating element 12 may be performed only by two power supply lines 123-1 and 123-2.

Four coils 121-1, 121-2, 121-3, and 121-4 may have the same size and shape and may be spaced apart from one another at regular intervals. However, one or more embodiments are not limited thereto, and the number, sizes, and shapes of coils may change according to necessity.

When the coils 121-1, 121-2, 121-3, and 121-4 are arranged, a magnetic field generated by coils, which are symmetrically arranged with respect to the accommodation portion 11, may be offset from each other.

In FIG. 7, the first coil 121-1 and the third coil 121-3 are symmetrically arranged with respect to the accommodation portion 11, and the second coil 121-2 and the fourth coil 121-4 are symmetrically arranged with respect to the accommodation portion 11.

In FIG. 8, a direction of a current flowing in each coil included in the heating element 12 is indicated by an arrow. When an alternating current is applied to the heating element 12, the current direction keeps changing according to a frequency of the alternating current, and thus, the current direction illustrated in FIG. 8 may be temporary at a specific point in time.

When the heating element 12 of FIG. 8 is arranged to surround the outer circumferential surface of the accommodation portion 11, the first coil 121-1 may face the third coil 121-3 with respect to the accommodation portion 11, as illustrated in FIG. 7. In the above arrangement, the first coil 121-1 and the third coil 121-3 may have the same coil winding direction, central axis of the coil winding, and rotation direction (the clockwise direction or the counterclockwise direction) of the current flowing therein.

As described, the second coil 121-2 and the fourth coil 121-4 may be arranged to face each other with respect to the accommodation portion 11 and may have the same coil winding direction, central axis of the coil winding, and rotation direction (the clockwise direction or the counterclockwise direction) of the current flowing therein.

Because of the arrangements described above, although the heating element 12 includes four or more coils that are integrally formed, the offset ratio of the magnetic fields may be minimized.

Moreover, according to the arrangements, because there is no need to separately control respective coils to prevent the magnetic field from being offset, the magnetic fields generated by the coils 121-1, 121-2, 121-3, and 121-4 may not be offset by controlling only a circuit system including the heating element 12 including one conducting wire, and thus, it may be easy to control the circuit system.

FIG. 9 is a block diagram of an aerosol generating device 10 according to another embodiment.

The aerosol generating device 10 may include the accommodation portion 11 (not shown in FIG. 9), the beating element 12, the battery 13, the controller 14, a sensing unit 15, an output unit 16, a communication unit 17, a memory 18, and a user input unit 19. However, the internal structure of the aerosol generating device 10 is not limited to those illustrated in FIG. 9. That is, according to the design of the aerosol generating device 10, it will be understood by one of ordinary skill in the art that some of the components shown in FIG. 9 may be omitted or new components may be added.

The sensing unit 15 may sense a state of the aerosol generating device 10 and a state around the aerosol generating device 10, and transmit sensed information to the controller 14. Based on the sensed information, the controller 14 may control the aerosol generating device 10 to perform various functions, such as controlling an operation of the heating element 12, limiting smoking, determining whether an aerosol generating article (e.g., a cigarette, a cartridge, or the like) is inserted, displaying a notification, or the like.

The sensing unit 15 may include at least one of a temperature sensor 151, an insertion detection sensor 152, and a puff sensor 153, but is not limited thereto.

The temperature sensor 151 may sense a temperature at which the heating element 12 (or an aerosol generating material) is heated. The aerosol generating device 10 may include a separate temperature sensor for sensing the temperature of the heating element 12, or the heating element 12 may serve as a temperature sensor. Alternatively, the temperature sensor 151 may also be arranged around the battery 13 to monitor the temperature of the battery 13.

The insertion detection sensor 152 may sense insertion and/or removal of an aerosol generating article. For example, the insertion detection sensor 152 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article. For example, the insertion detection sensor 152 may sense insertion of a susceptor into the aerosol generating article and sense insertion and/or removal of the aerosol generating article. In this case, the susceptor may not only heat the aerosol generating article, but serve as a sensing target of the aerosol generating article.

The puff sensor 153 may sense a user's puff on the basis of various physical changes in an airflow passage or an airflow channel. For example, the puff sensor 153 may sense a user's puff on the basis of any one of a temperature change, a flow change, a voltage change, and a pressure change.

The sensing unit 15 may include, in addition to the temperature sensor 151, the insertion detection sensor 152, and the puff sensor 153 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 16 may output information on a state of the aerosol generating device 10 and provide the information to a user. The output unit 16 may include at least one of a display unit 161, a haptic unit 162, and a sound output unit 163, but is not limited thereto. When the display unit 161 and a touch pad form a layered structure to form a touch screen, the display unit 161 may also be used as an input device in addition to an output device.

The display unit 161 may visually provide information about the aerosol generating device 10 to the user. For example, information about the aerosol generating device 10 may mean various pieces of information, such as a charging/discharging state of the battery 13 of the aerosol generating device 10, a preheating state of the heating element 12, an insertion/removal state of an aerosol generating article, or a state in which the use of the aerosol generating device 10 is restricted (e.g., sensing of an abnormal object), or the like, and the display unit 161 may output the information to the outside. The display unit 161 may be, for example, a liquid crystal display panel (LCD), an organic light-emitting diode (OLED) display panel, or the like. In addition, the display unit 161 may be in the form of a light-emitting diode (LED) light-emitting device.

The haptic unit 162 may tactilely provide information about the aerosol generating device 10 to the user by converting an electrical signal into a mechanical stimulus or an electrical stimulus. For example, the haptic unit 162 may include a motor, a piezo-electric element, or an electrical stimulation device.

The sound output unit 163 may audibly provide information about the aerosol generating device 10 to the user. For example, the sound output unit 163 may convert an electrical signal into a sound signal and output the same to the outside.

The battery 13 may supply power used to operate the aerosol generating device 10. The battery 13 may supply power such that the heating element 12 may be heated. In addition, the battery 13 may supply power required for operations of other components (e.g., the sensing unit 15, the output unit 16, the user input unit 19, the memory 18, and the communication unit 17) in the aerosol generating device 10. The battery 13 may be a rechargeable battery or a disposable battery. For example, the battery 13 may be a lithium polymer (LiPoly) battery, but is not limited thereto.

The heating element 12 may receive power from the battery 13 to heat an aerosol generating material. Although not illustrated in FIG. 9, the aerosol generating device 10 may further include a power conversion circuit (e.g., a direct current (DC)/DC converter) that converts power of the battery 13 and supplies the same to the heating element 12. In addition, when the aerosol generating device 10 generates aerosols in an induction heating method, the aerosol generating device 10 may further include a DC/alternating current (AC) that converts DC power of the battery 13 into AC power.

The controller 14, the sensing unit 15, the output unit 16, the user input unit 19, the memory 18, and the communication unit 17 may each receive power from the battery 13 to perform a function. Although not illustrated in FIG. 9, the aerosol generating device 10 may further include a power conversion circuit that converts power of the battery 13 to supply the power to respective components, for example, a low dropout (LDO) circuit, or a voltage regulator circuit.

The user input unit 19 may receive information input from the user or may output information to the user. For example, the user input unit 19 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 10 may further include a connection interface, such as a universal serial bus (USB) interface, and may connect to other external devices through the connection interface, such as the USB interface, to transmit and receive information, or to charge the battery 13.

The memory 18 is a hardware component that stores various types of data processed in the aerosol generating device 10, and may store data processed and data to be processed by the controller 14. The memory 18 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 18 may store an operation time of the aerosol generating device 10, the maximum number of puffs, the current number of puffs, at least one temperature profile, data on a user's smoking pattern, etc.

The communication unit 17 may include at least one component for communication with another electronic device. For example, the communication unit 17 may include a short-range wireless communication unit 171 and a wireless communication unit 172.

The short-range wireless communication unit 171 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 172 may include a cellular network communication unit, an Internet communication unit, a computer network (e.g., local area network (LAN) or wide area network (WAN)) communication unit, or the like, but is not limited thereto. The wireless communication unit 172 may also identify and authenticate the aerosol generating device 10 within a communication network by using subscriber information (e.g., International Mobile Subscriber Identifier (IMSI)).

The controller 14 may control general operations of the aerosol generating device 10. In an embodiment, the controller 14 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 14 may control the temperature of the heating element 12 by controlling supply of power of the battery 13 to the heating element 12. For example, the controller 14 may control power supply by controlling switching of a switching element between the battery 13 and the heating element 12. In another example, a direct heating circuit may also control power supply to the heating element 12 according to a control command of the controller 14.

The controller 14 may analyze a result sensed by the sensing unit 15 and control subsequent processes to be performed. For example, the controller 14 may control power supplied to the heating element 12 to start or end an operation of the heating element 12 on the basis of a result sensed by the sensing unit 15. As another example, the controller 14 may control, based on a result sensed by the sensing unit 15, an amount of power supplied to the heating element 12 and the time the power is supplied, such that the heating element 12 may be heated to a certain temperature or maintained at an appropriate temperature.

The controller 14 may control the output unit 16 on the basis of a result sensed by the sensing unit 15. For example, when the number of puffs counted through the puff sensor 153 reaches a preset number, the controller 14 may notify the user that the aerosol generating device 10 will soon be terminated through at least one of the display unit 161, the haptic unit 162, and the sound output unit 163.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing forming an exterior and having an inner space;
an accommodation portion arranged inside the housing and configured to accommodate an aerosol generating article;
a battery arranged inside the housing; and
a heating element arranged inside the housing and configured to generate a magnetic field according to power supplied from the battery, wherein at least a portion of the heating element forms a plurality of coils configured to generate the magnetic field, and
the plurality of coils are electrically connected to each other, arranged along an outer circumferential surface of the accommodation portion, and configured to generate the magnetic field in a direction crossing a direction, in which the accommodation portion extends, when the power is supplied from the battery.

2. The aerosol generating device of claim 1, wherein the plurality of coils are curved in a shape surrounding the outer circumferential surface of the accommodation portion.

3. The aerosol generating device of claim 1, wherein the plurality of coils are spaced apart from each other at regular intervals.

4. The aerosol generating device of claim 1, wherein at least some of the plurality of coils face each other with respect to the accommodation portion and have a same central axis and direction around which the plurality of coils are wound.

5. The aerosol generating device of claim 1, wherein the plurality of coils are electrically connected to the battery through two power supply lines and thus receive power from the battery.

6. The aerosol generating device of claim 1, wherein at least some of the plurality of coils comprise a circular shape in which a radius is uniform with respect to a central axis around which the plurality of coils are wound.

7. The aerosol generating device of claim 1, wherein the accommodation portion comprises a protrusion protruding from at least a region of the outer circumferential surface of the accommodation portion in a radial direction of the accommodation portion, the protrusion supporting the heating element.

8. The aerosol generating device of claim 1, wherein, when a current is applied to the heating element, a resonant frequency of a current flowing in the plurality of coils is greater than or equal to about 1 MHZ and less than or equal to about 10 MHZ.

9. An aerosol generating system comprising:
an aerosol generating article comprising an aerosol generating material;
a housing forming an exterior and having an inner space;
an accommodation portion arranged inside the housing and configured to accommodate the aerosol generating article;
a battery arranged inside the housing;
a heating element arranged inside the housing and configured to generate a magnetic field according to power supplied from the battery; and
a susceptor emitting heat because of the magnetic field generated by the heating element and configured to heat the aerosol generating article, wherein at least a portion of the heating element forms a plurality of coils configured to generate the magnetic field, and
the plurality of coils are electrically connected to each other, arranged along an outer circumferential surface of the accommodation portion, and configured to generate the magnetic field in a direction crossing a direction, in which the accommodation portion extends, when the power is supplied from the battery.

10. The aerosol generating system of claim 9, wherein the susceptor is arranged to surround at least a portion of the aerosol generating article.

11. The aerosol generating system of claim 9, wherein the susceptor forms a thin film.

12. The aerosol generating system of claim 11, wherein the susceptor is arranged such that the susceptor and the accommodation portion extend in a same direction.

13. The aerosol generating system of claim 11, wherein the susceptor is arranged inside the aerosol generating article.

14. The aerosol generating system of claim 13, wherein the susceptor is arranged such that the susceptor and the aerosol generating article extend in a same direction.

15. The aerosol generating system of claim 9, wherein a thickness of the susceptor is greater than or equal to about 1 μm and less than or equal to about 100 μm, and,
when a current is applied to the heating element, a resonant frequency of the current flowing in the heating element is greater than or equal to about 1 MHz. and less than or equal to about 10 MHZ.
